(19) United States
(12) Patent Application Publication
(10) Pub. No.: US 2025/0095334 A1
(43) Pub. Date: Mar. 20, 2025

(54) METHOD AND SYSTEM FOR IMPROVING POINT CLOUD CLASSIFICATION ACCURACY BASED ON GRAPH SPECTRAL DOMAIN

(71) Applicant: PEKING UNIVERSITY, Beijing (CN)

(72) Inventors: Wei HU, Beijing (CN); Daizong LIU, Beijing (CN)

(21) Appl. No.: 18/289,159

(22) PCT Filed: Nov. 25, 2022
(86) PCT No.: PCT/CN2022/134233

§ 371 Date: Nov. 1, 2023

(30) Foreign Application Priority Data
Nov. 22, 2022 (CN) 202211468842.0

(51) Int. Cl. G06V 10/764; G06T 5/10; G06T 5/20; G06T 17/00

(52) U.S. Cl. CPC G06V 10/764; G06T 5/10; G06T 5/20; G06T 17/00

(57) ABSTRACT

The present invention discloses a method and system for enhancing the accuracy of point cloud classification in the spectral domain, relating to the field of point cloud classification. The method comprises the following steps: acquiring original point cloud data of 3D objects; constructing a KNN graph on the original point cloud to represent the geometric structural information, wherein the KNN graph transforms the original point cloud data from the data domain to the spectral domain using GFT; constructing spectral filters to filter the spectral features of the data transformed to the spectral domain, generating perturbed spectral signals; reverting the perturbed spectral signals back to the data domain through GFT, obtaining adversarial point cloud data; generating samples based on the original point cloud data and adversarial samples based on the adversarial point cloud data, serving as training data, and inputting them into the point cloud classification model for classification training; using the trained point cloud classification model to classify the original point cloud data of the target 3D object and producing a classification result. This invention can enhance the accuracy of point cloud classification and recognition by the model.

### TECHNICAL FIELD

The present invention relates to the field of point cloud classification, and more specifically, it pertains to a method and system for enhancing the classification accuracy of 3D point cloud models using adversarial sample generation based on graph spectral domain.

### BACKGROUND OF THE INVENTION

By acquiring key point information with three-dimensional structural characteristics from 3D objects, a three-dimensional point cloud dataset is composed. Subsequently, a point cloud classification model is employed to recognize and classify these point cloud data, thereby identifying/categorizing the 3D objects represented by the point cloud data. However, the performance of existing point cloud classification models is constrained by the limitations of manually annotated datasets. Due to the finite size of the dataset, point cloud classification models often approximate the general data distribution, thus failing to capture the true data space. To address this issue, existing approaches utilize adversarial sample generation to learn potentially disruptive samples for the point cloud classification model. These samples are then introduced into the model as challenging data, further enhancing the model training process and thereby improving classification accuracy.

Currently, existing methods for generating adversarial samples for 3D point cloud models can be mainly categorized into two types: (1) Methods based on adding/dropping points: Xiang et al. introduced a method where a limited number of perturbed points, point clusters, or object compositions made of point clusters are added to the original point cloud to generate adversarial point clouds. The effectiveness of this approach was confirmed on the PointNet point cloud classification model. Additionally, other approaches utilize gradient-based methods to identify key points within the point cloud and modify, add, or delete them. The objective of these adversarial point cloud generation methods is to change the classification scores of the network model for overall point cloud labels by adding or removing individual key points identified for 3D objects. (2) Methods based on point-wise perturbation for adversarial point cloud generation: The initial point-wise perturbation methods often employed the C&W algorithm framework constrained by Chamfer and Hausdorff distances to learn and find perturbation magnitudes for each point in the point cloud. This altered the corresponding 3D xyz coordinates to create adversarial point clouds. Subsequently, recent work has used iterative gradient-based methods to generate finer-grained adversarial perturbations, enhancing the performance of adversarial perturbations within the C&W algorithm strategy. To maintain the geometric features of 3D objects as much as possible, Liu et al. proposed perturbing each point not along the 3D xyz direction, but along the direction of the tangent plane normal within a limited and strict boundary width to preserve geometric smoothness between adjacent points.

While both of the aforementioned types of adversarial point cloud generation methods have achieved significant success rates, they both utilize coordinate shifts in data space to achieve perturbation, which presents the following two bottlenecks: (1) Existing point cloud perturbation methods alter coordinates directly to introduce noise interference. This perturbation strategy easily results in generated adversarial point clouds containing outlier points and uneven point distributions in local areas. (2) Existing point cloud perturbation methods do not consider preserving the geometric characteristics of the original 3D point cloud, such as piecewise smoothness, which manifests as slowly changing underlying surfaces separated by sharp edges. However, whether through methods that modify local points or perturbations applied globally along the xyz direction, they directly deform the geometric structure of the original point cloud, leading to the loss of its geometric properties.

### SUMMARY OF THE INVENTION

To address the issue of low classification accuracy in existing point cloud classification models, the present invention introduces a method and system for enhancing the accuracy of point cloud classification models through adversarial sample generation based on the graph domain. By capturing and preserving the geometric characteristics of 3D objects, imperceptible noise perturbations are introduced into the 3D point cloud. This generates adversarial point clouds tailored to challenge the point cloud classification model. These adversarial samples are then incorporated into the training process of the point cloud classification model, further enhancing the model's classification accuracy. In essence, the invention aims to improve the model's ability to accurately classify and identify 3D objects based on point cloud data by leveraging graph domain-based adversarial sample generation to introduce subtle noise perturbations that retain the geometric characteristics of the original 3D objects.

To achieve the aforementioned objectives, the present invention employs the following technical solution:
A method for enhancing point cloud classification accuracy based on the graph domain is provided, comprising the following steps:
Obtaining raw point cloud data of 3D objects;
Constructing a k-Nearest Neighbor Graph (KNN graph) on the raw point cloud to represent the geometric structural information of the point cloud. This KNN graph is transformed from the data domain to the graph domain using Graph Fourier Transform (GFT);
Building graph filters to filter the spectral features of the data transformed into the graph domain, generating perturbed spectral signals;
Using Inverse Graph Fourier Transform (IGFT), converting the perturbed spectral signals back to the data domain to obtain adversarial point cloud data;
Constructing samples based on the original point cloud data and adversarial samples based on the generated adversarial point cloud data. These samples are used as training data and fed into the point cloud classification model for training;
Utilizing the trained point cloud classification model to classify the raw point cloud data of the 3D objects and output the classification results.

Preferably, the graph filters can be polynomial functions of the spectral eigenvalues. The transformation into the graph domain is perturbed in a learnable manner, generating perturbed spectral signals by minimizing adversarial loss.

Preferably, the adversarial loss can be composed of a cross-entropy loss function used to promote adversarial misclassification, a regularization term, and a low-frequency constraint term.

A system for enhancing point cloud classification accuracy based on the graph domain is also presented, comprising a memory and a processor. The memory stores a computer program, and the processor executes the program to implement the aforementioned method's steps.

In comparison to existing techniques, the advantages of this invention are as follows:

Typically, signals can represent geometric features of data in the graph domain, which is crucial for point cloud classification tasks. Therefore, this invention delves into effective analysis and preservation of 3D object geometry and introduces a novel approach using the graph domain to generate adversarial samples. This, in turn, enhances the accuracy of point cloud classification models through training. Unlike traditional point cloud perturbation methods in the data space, the innovation of this invention lies in the first-time utilization of graph domain representation of 3D object geometry. It designs graph filters to perturb the Graph Fourier Transform coefficients, explicitly retaining key geometric structures. Each graph frequency represents certain structural features of the point cloud, corresponding to global or local geometric context information. Hence, studying frequency components and their correlation with geometric information in the point cloud is crucial. When appropriately perturbing specific frequency bands, the corresponding changes in geometric structures reflected in the data domain could be minimal, rendering them difficult to detect for point cloud classification networks.

### BRIEF DESCRIPTION OF THE DRAWINGS

FIG. 1 illustrates a schematic diagram of the method proposed in this invention for enhancing point cloud classification accuracy based on the graph domain.

FIG. 2 depicts a graph distribution diagram for studying 3D objects.

FIG. 3 displays a graph domain analysis of 3D point clouds.

FIG. 4 showcases visual results of the adversarial point clouds generated by the method of this invention.

FIG. 5 presents a visual comparison of the adversarial point clouds generated by the method of this invention and the existing method GeoA in both spatial and frequency domains.

FIG. 6 demonstrates a visual comparison of the adversarial sample generation method proposed in this invention under the presence and absence of low-frequency constraint (with LFC and without LFC).

### DETAILED DESCRIPTION OF THE INVENTION

In order to make the above features and advantages of the present invention more comprehensible, specific embodiments are provided below, accompanied by detailed explanations with reference to the accompanying figures.

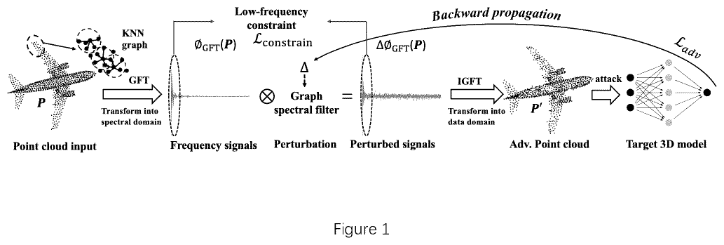

The specific embodiment of the present invention proposes a method to enhance point cloud classification accuracy through graph domain-based adversarial sample generation, as illustrated in the schematic diagram shown in FIG. 1. The overall processing steps of this method are outlined as follows:

Firstly, acquire point cloud data of clean 3D objects.

Next, construct a K-nearest neighbors (KNN) graph structure and transform the point cloud to the spectral domain through Graph Fourier Transform (GFT).

Then, employ specially designed spectral filters to perturb the original GFT coefficients in a learnable manner.

Subsequently, revert the perturbed spectral signals back to the data domain using Inverse Graph Fourier Transform (IGFT) to build adversarial point cloud sample data.

Finally, utilize this adversarial point cloud sample data to train a point cloud classification model, enhancing the model's classification accuracy for the target 3D objects based on their point cloud data.

In this method, Graph Fourier Transform (GFT) and Inverse Graph Fourier Transform (IGFT) are techniques belonging to the field of graph signal processing. Their specific explanations are as follows:

In this method, the graph signal x∈ [symbol] ⁿ is represented by a graph [symbol] ={ [symbol] , ε, A}, where [symbol] is the node set of the graph, | [symbol] |=n; ε is the edge set. A∈ [symbol] ^{n×n} is the adjacent matrix, which is a real symmetric matrix, the element a_{i,j} denotes the edge weight between nodes i and j. Among the transformation operators in graph signal processing, given the piecewise smooth nature of point clouds, this method focuses more on the graph Laplacian matrix. L:=D−A, where D is diagonal matrix, d_{i,i} represents the degree of each node. Given real and nonnegative edge weights in an undirected graph, L is real, symmetric, and positive semidefinite. Therefore, it can be eigen-decomposed L=UΛU^{T}, where U is an orthogonal matrix containing the eigenvectors, Λ=diag(λ₁ . . . λₙ) is composed of eigenvalues {λ₁=0≤λ₂≤ . . . ≤λₙ}. In graph signal processing theory, the aforementioned eigenvalues are called graph frequencies/spectrums, where smaller eigenvalues correspond to lower graph frequencies.

For any graph signal x∈ [symbol] ⁿ, its graph Fourier transform (GFT) can be defined as:

$$\hat{x} = {ϕ}_{GFT} ( x ) = {U}^{T} x$$

Its inverse graph Fourier transform (IGFT) can be defined as:

$$x = {ϕ}_{IGFT} ( \hat{x} ) = U \hat{x}$$

If a graph is properly constructed on the given input data to capture the structure of the signal well, its GFT transformation will lead to a compact representation of the graph signal in the spectral domain. Since U is an orthonormal matrix, both GFT and IGFT operations are lossless.

Let h(λᵢ), (i=1, 2, . . . , n) denote the frequency response of a graph spectral filtering, then the filtering takes the form:

$${x}^{′} = U [ \begin{matrix}h ( {λ}_{1} ) & & \\ & ⋱ & \\ & & h ( {λ}_{n} )\end{matrix} ] {U}^{T} x$$

where the filter first transforms the data x onto the GFT domain U^{T}x, then performs filtering on each eigenvalue (i.e., the spectrum of the graph), and finally projects back to the spatial domain via the inverse GFT to acquire the filtered output x′.

For instance, an intuitive realization of low-pass graph spectral filtering is to completely eliminate all graph frequencies above a given bandwidth b while keeping those below unchanged:

$$h ( {λ}_{i} ) = \{ \begin{matrix}0 , & i > b \\ 1 , & i \leq b\end{matrix}$$

In this method, the spectral domain and the spectral filter use the spectral domain characteristics of the 3D point cloud. The following describes the spectral domain of the 3D point cloud:

In general, when an appropriate graph is constructed that captures the geometric structure of point clouds well, the low-frequency components of the corresponding GFT mainly characterize the rough shape of point clouds, while the high-frequency components represent fine details or noise (i.e., large variations such as geometric contours) of the 3D objects. This is because the variation of the eigenvectors (i.e., the GFT basis) of the graph Laplacian matrix gradually increases from low frequencies to high frequencies, capturing more and more detailed structure of the 3D object. For example, all values in the first eigenvector are 1, which represents the smooth surface, while values in the last eigenvector are alternately positive and negative for representing fine details.

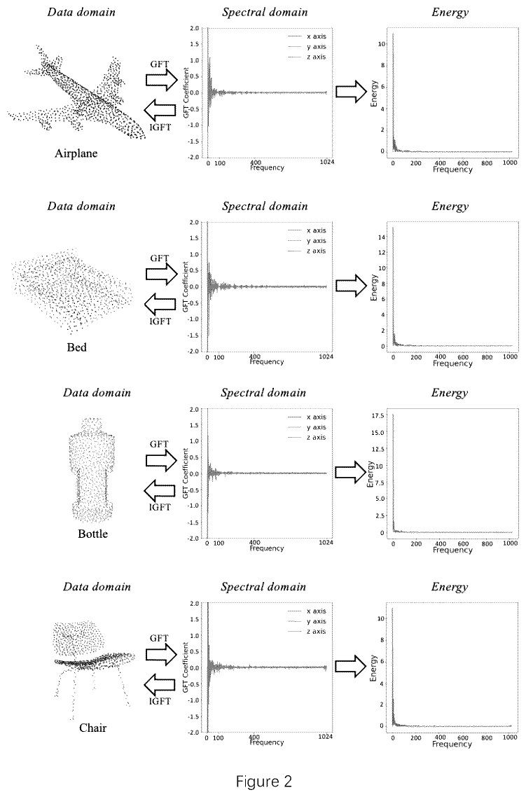

Further, this method provides an intuitive example with in-depth analysis for the understanding of the spectral characteristics, i.e., how each frequency band contributes to the geometric structure of a point cloud in the data domain. This method provides an example in FIG. 2 to investigate the spectrums of 3D point cloud. Specifically, this method transforms each point cloud into the spectral domain and investigate its GFT coefficients and energy. It can be found that, the GFT coefficients has larger amplitudes in lower-frequency components and much smaller amplitudes in higher-frequency components, demonstrating that most information is concentrated in low-frequency components. That is, a point cloud is a low-pass signal when the graph is appropriately constructed. Since there is no official principle for the definition of different frequency bands, this method proposes to divide the entire spectral domain into three bands via the distribution of energy—the squared sum of transform coefficients. As shown in FIG. 2, point clouds have almost 75% of energy within the lowest 100 frequencies and almost 90% of energy within the lowest 400 frequencies. Based on this observation, this method sets three frequency bands for point clouds in the ModelNet40 dataset: the low-frequency band (frequency [0,100)), the mid-frequency band (frequency [100,400)), and the high-frequency band (frequency [400, 1024)).

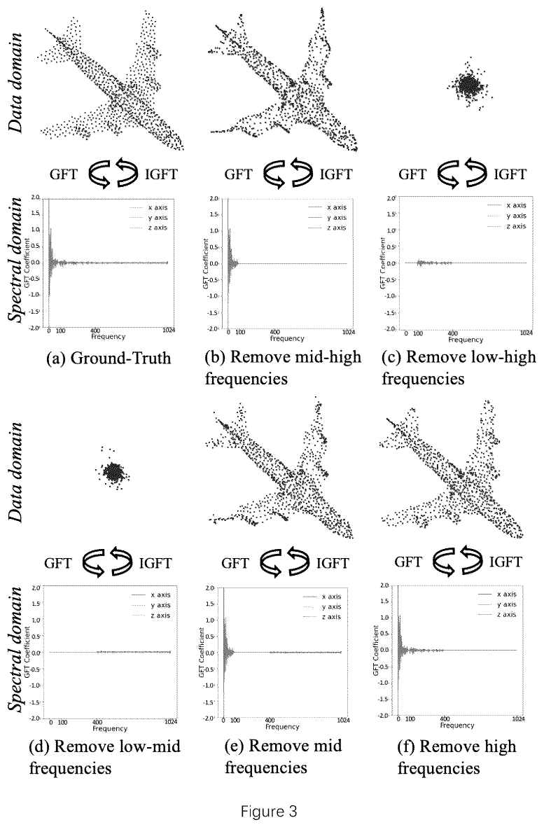

In addition, this example also studies the influence of each frequency band on the geometry by setting certain GFT coefficients to zero through spectral filtering. As shown in FIG. 3, it is the graph domain analysis diagram of the 3D point cloud. Taking a 3D aircraft as an example, the effects of different frequency bands are studied by removing certain frequency components in the spectral domain. Among them, (a) picture shows the original point cloud and spectrum information; (b) picture shows the removal of mid-high frequency; (c) picture shows the removal of low frequency and high frequency; (d) picture shows the removal of low frequency and intermediate frequency; (e) picture shows the removal of Intermediate frequency; (f) shows the removal of high frequency. When the GFT coefficients of the middle and high frequency bands are set to zero, the point cloud reconstructed with only the low frequency bands can only present the rough shape of the original object, lacking fine details, such as the edge of the wing. Panels (c) and (d) of FIG. 3 show point clouds reconstructed using only the mid-band or high-band, respectively, further demonstrating the importance of the low-band for constructing the shape of 3D objects. By adding more information from mid-frequency or high-frequency in FIG. 3(b), the reconstructed point cloud has richer local context, as shown in FIGS. 3(e) and (f), but it still lacks of fine-grained details, such as aircraft engines. In summary, each frequency band represents a different aspect of the geometric properties of the point cloud. In particular, the low-frequency band represents the most basic contour geometry of the 3D point cloud, and the high-frequency band represents the local fine details and noise of the object.

Based on the above-mentioned graph signal processing and graph domain characteristics, this method generates adversarial samples based on the graph domain to train the point cloud classification model. This method selectively perturbs some frequencies in the graph domain of the point cloud to best maintain the basic geometric information. Specifically, this method learns a specific distribution of the graph domain (i.e., the eigenvalues of the graph Laplacian matrix) to apply a perturbation in order to transform the latent features of the original point cloud into another feature of a different class.

In this method, given a clean point cloud P={pᵢ}ᵢ₌₁ⁿ∈ [symbol] ^{n×3}, where each point pᵢ∈ [symbol] ³ is a vector that contains the coordinates, a well-trained point cloud classifier f(⋅) can predict its accurate label y=f(P)∈ [symbol] [symbol] ={1,2,3, . . . , c}, where c is the number of classes. The goal of point cloud attacks on classification is to deform the point cloud P into the adversarial one P′, so that f(P′)=y′ (targeted attack) or f(P′)≠y (untargeted attack), where y′∈ [symbol] but y′≠y.

This method proposes a novel graph spectral domain attack that aims to learn destructive yet imperceptible perturbations in the spectral domain to generate adversarial point clouds. In particular, the objective is to learn perturbations in the spectral domain that minimize the adversarial loss for preserving the geometric characteristics of the 3D object, under the distance constraint between the GFT coefficients before and after the attack. The attack is realized by graph spectral filtering in the GFT domain. Formally, the proposed attack can be formulated as the following optimization problem:

$${min}_{Δ} {L}_{a d v} ( {P}^{′} , P , y ) , ‖ {ϕ}_{GFT} ( {P}^{′} ) - {ϕ}_{GFT} ( P ) {‖}_{p} < ϵ ,$$

$$where$$

$${P}^{′} = {ϕ}_{IGFT} ( Δ ( {ϕ}_{GFT} ( P ) ) ,$$

$$Δ = [ \begin{matrix}{Δ}_{w , 1} \cdot {Σ}_{k = 0}^{K - 1} {Δ}_{h , k} {λ}_{1}^{k} & & \\ & ⋱ & \\ & & {Δ}_{w , n} \cdot {Σ}_{k = 0}^{K - 1} {Δ}_{h , k} {λ}_{n}^{k}\end{matrix} ]$$

where L_{adv}(P′, P, y) is the adversarial loss and Δ is the learnable perturbation in the spectral domain. In the imposed constraint, ε is a threshold that aims to restrict the size of the perturbation in the spectral domain, which preserves the original spectral characteristics so that the resultant adversarial point cloud P′ is visually indistinguishable from its clean version P. To achieve the perturbation in the spectral domain, this method performs filtering on each GFT coefficient, where the graph spectral filter is a polynomial function of the eigenvalues so as to fit a desirable spectral distribution. Specifically, {Δ_{w,i}}ᵢ₌₁ⁿ is utilized to learn the contribution of each frequency component, {Δ_{h,k}}ₖ₌₀^{K} highlights the contributed frequency components, i and k are the index, n and K are the total number.

To back-propagate the gradient in a desired direction for optimizing the perturbation learning, the adversarial loss L_{adv}(P′, P, y) is defined as:

$${L}_{a d v} ( {P}^{′} , P , y ) = {L}_{c l a s s} ( {P}^{′} , y ) + {L}_{r e g} ( {P}^{′} , P ) + {L}_{c o n s t r a i n} ( \tilde{{P}^{′}} , \tilde{P} )$$

where L_{class}(P′, y) promotes the misclassification of the point cloud P′, the cross-entropy loss is defined as:

$${L}_{c l a s s} ( {P}^{′} , y ) = \{ \begin{matrix}- {log}_{e} ( {p}_{{y}^{′}} ( {P}^{′} ) ) , & for targeted attack \\ {log}_{e} ( {p}_{y} ( {P}^{′} ) ) , & for untargeted attack\end{matrix}$$

where p(⋅) is the softmax functioned on the output of the target model, i.e., the probability with respect to adversarial class y′. By minimizing this loss function, the proposed attack optimizes the spectral perturbation Δ to mislead the target model f(⋅). In addition, L_{reg}(P′, P) is the regularization term that minimizes the distance between P′ and P to guide the perturbation as appropriate frequencies. L_{constrain}(\tilde{P}′, \tilde{P}) is the proposed low-frequency constraint to preserve the shape of the 3D object and limit the perceptible noise. \tilde{P}′, \tilde{P} are the reconstructed point cloud based on only the low-frequency components of P′, P.

In order to preserve the basic geometric structure of the original 3D object, this method further proposes a low-frequency constraint to restrict more perturbations from being added to imperceptible high-frequency components. Although our method adds and optimizes perturbations in the spectral domain, these perturbations may perturb certain spectral features, leading to perceptible structural changes in local regions of the map in the spatial domain data. On the other hand, traditional constrained optimization may result in random distribution of perturbations across the spectrum. Therefore, this method restricts the generation of perturbations through a new constraint, making them imperceptible after acting on the original point cloud. Since low-frequency components mainly affect the silhouette shape of 3D objects, our method imposes constraints on the spectral perturbations on these components to guide the perturbations to concentrate more on high-frequency components representing fine details.

Specifically, in order to preserve the prominent structure information of the original object, this method sets the high-frequency components of both the benign point cloud P and its adversarial example P′ to zero, and reconstruct the new point cloud with only their low-frequency components as follows:

$$\tilde{P} = U [ \begin{matrix}h ( {λ}_{1} ) & & \\ & ⋱ & \\ & & h ( {λ}_{n} )\end{matrix} ] {U}^{T} P$$

$$\tilde{{P}^{′}} = U [ \begin{matrix}h ( {λ}_{1} ) & & \\ & ⋱ & \\ & & h ( {λ}_{n} )\end{matrix} ] {U}^{T} {P}^{′}$$

where h(λᵢ) is a low-pass graph filter as follow:

$$h ( {λ}_{i} ) = \{ \begin{matrix}0 , & i > b \\ 1 , & i \leq b\end{matrix}$$

Here, b is the upper bound of the low-frequency band and set to 400. Hence, the proposed low-frequency constraint between the benign and adversarial point clouds is:

$${L}_{c o n s t r a i n} ( \tilde{{P}^{′}} , \tilde{P} ) = {‖ \tilde{P} - \tilde{{P}^{′}} ‖}_{2}$$

At last, this method feeds the high-quality adversarial examples into the point cloud classification model for training and improving the accuracy.

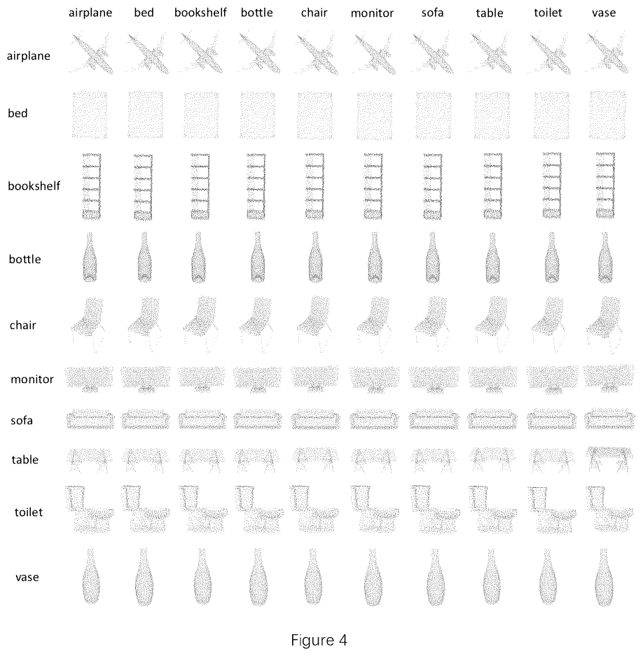

As shown in FIG. 4, the adversarial examples generated by this method are imperceptible.

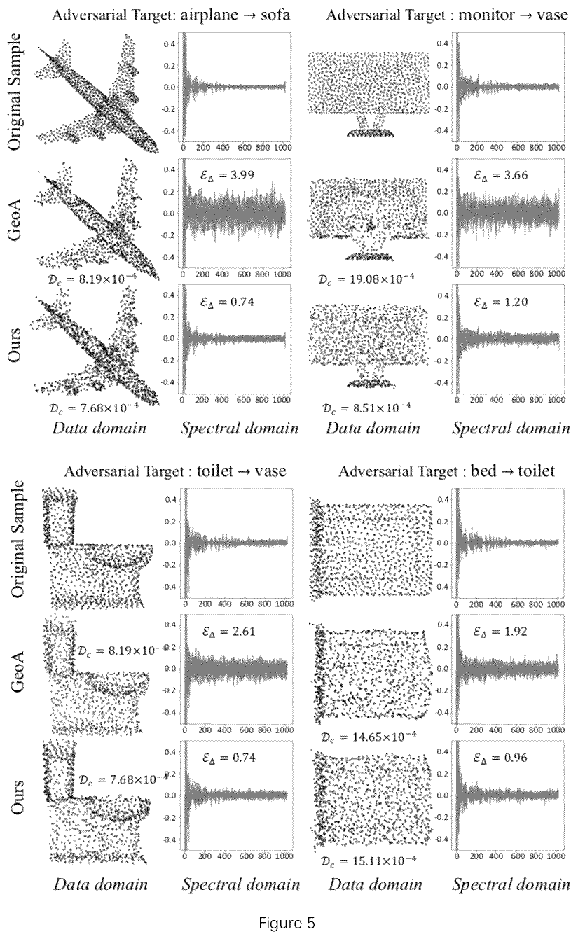

FIG. 5 shows the degree of distortion of the adversarial samples generated by different methods, and it can be seen that the spectral domain distortion of the present invention is the lowest.

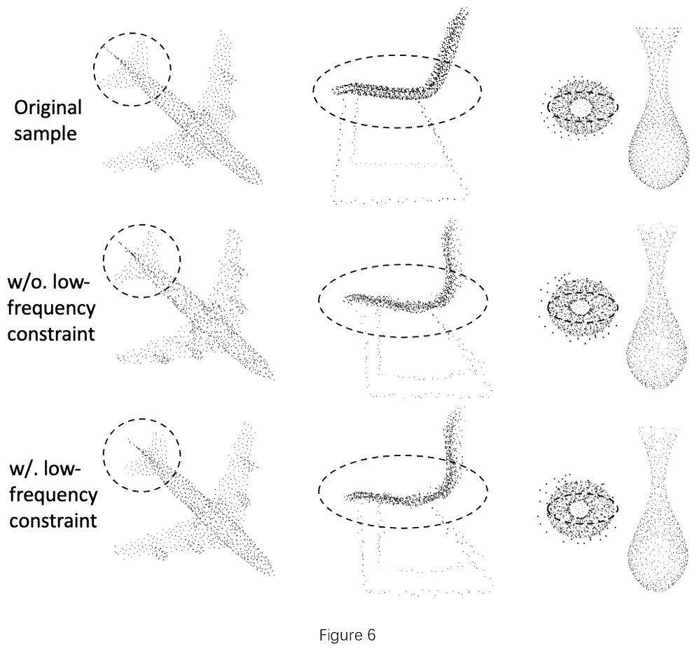

FIG. 6 demonstrates the effectiveness of the low-frequency constraints proposed by the present invention to generate higher-quality adversarial examples.

In addition to 3D point cloud data, this method can also be used on 3D grid data and similar data.

Table 1 shows the confrontation performance results of different point cloud classification networks on the ModelNet40 dataset, where the smaller the perturbation size, the better.

TABLE 1

| Attack | | Success | Perturbation Size | | | |
|---|---|---|---|---|---|---|
| Model | Methods | Rate | [symbol] ₙₒᵣₘ | [symbol] _{c} | [symbol] ₕ | [symbol] _{g} |
| PointNet | FGSM | 100% | 0.7936 | 0.1326 | 0.1853 | 0.3901 |
| | 3D-ADV | 100% | 0.3032 | 0.0003 | 0.0105 | 0.1772 |
| | GeoA | 100% | 0.4385 | 0.0064 | 0.0175 | 0.0968 |
| | GSDA | 100% | 0.1741 | 0.0007 | 0.0033 | 0.0817 |
| | GSDA++ | 100% | 0.1517 | 0.0006 | 0.0028 | 0.0633 |
| PointNet++ | FGSM | 100% | 0.8357 | 0.1682 | 0.2275 | 0.4143 |
| | 3D-ADV | 100% | 0.3248 | 0.0005 | 0.0381 | 0.2034 |
| | GeoA | 100% | 0.4772 | 0.0198 | 0.0357 | 0.1141 |
| | GSDA | 100% | 0.2072 | 0.0081 | 0.0248 | 0.1075 |
| | GSDA++ | 100% | 0.1664 | 0.0065 | 0.0128 | 0.0986 |
| DGCNN | FGSM | 100% | 0.8549 | 0.189 | 0.2506 | 0.4217 |
| | 3D-ADV | 100% | 0.3326 | 0.0005 | 0.0475 | 0.2019 |
| | GeoA | 100% | 0.4933 | 0.0176 | 0.0402 | 0.1174 |
| | GSDA | 100% | 0.2160 | 0.0104 | 0,1401 | 0.1129 |
| | GSDA++ | 100% | 0.1731 | 0.0072 | 0.0135 | 0.0960 |
| PointTrans. | FGSM | 100% | 0.8332 | 0.1544 | 0.2379 | 0.4026 |
| | 3D-ADV | 100% | 0.3218 | 0.0006 | 0.0405 | 0.2012 |
| | GeoA | 100% | 0.4837 | 0.0185 | 0.0383 | 0.1164 |
| | GSDA | 100% | 0.1958 | 0.0073 | 0.0141 | 0.966 |
| | GSDA++ | 100% | 0.1579 | 0.0052 | 0.0058 | 0.0822 |
| PointMLP | FGSM | 100% | 0.8029 | 0.1374 | 0.1948 | 0.3853 |
| | 3D-ADV | 100% | 0.3162 | 0.0004 | 0.0279 | 0.1895 |
| | GeoA | 100% | 0.4578 | 0.0082 | 0.0235 | 0.0993 |
| | CSDA | 100% | 0.1782 | 0.0069 | 0.0090 | 0.0781 |
| | GSDA++ | 100% | 0.1463 | 0.0006 | 0.0021 | 0.0675 |

Note that: GSDA++ in Table 1 represents the method of the present invention.

Table 2 is a comparison of the robustness of different adversarial sample generation algorithms against different point cloud defense strategies for the PointNet classification network.

TABLE 2

| Attack | No Defense | SRS | DUP-Net | IF-Defense |
|---|---|---|---|---|
| FGSM | 100% | 9.68% | 4.38% | 4.80% |
| 3D-ADV | 100% | 22.53% | 15.44% | 13.70% |
| GeoA | 100% | 67.61% | 59.15% | 38.72% |
| GSDA | 100% | 81.03% | 68.98% | 50.26% |
| GSDA++ | 100% | 83.88% | 70.17% | 53.64% |

Note that: GSDA++ in Table 2 represents the method of the present invention.

Table 3 compares the robustness of different adversarial sample generation algorithms for PointNet classification networks to different data enhancement strategies.

TABLE 3

| Operation | FGSM | 3D-ADV | GeoA | GSDA++ |
|---|---|---|---|---|
| None | 100% | 100% | 100% | 100% |
| Scaling | 29.65% | 34.82% | 39.73% | 84.16% |
| Rotation | 43.74% | 48.31% | 51.08% | 87.69% |

Note that: GSDA++ in Table 3 represents the method of the present invention.

Table 4 shows the contribution of the adversarial examples generated by the present invention to the improvement of the accuracy of the point cloud classification model.

TABLE 4

| | PointNet | PointNet++ | DGCNN | PointTrans. | PointMLP |
|---|---|---|---|---|---|
| Accuracy | 89.25% | 91.9% | 92.2% | 93.75% | 94.5% |
| | PointNet* | PointNet++* | DGCNN* | PointTrans.* | PointMLP* |
| Accuracy | 90.1% | 92.6 | 92.9% | 94.3% | 95.2 |

Note that: * in Table 4 indicates the point cloud classification model retrained using the adversarial samples generated by this method.

Although the present invention has been disclosed as above with the embodiments, it is not intended to limit the present invention. Appropriate modifications or equivalent replacements to the technical solutions of the present invention by those of ordinary skill in the art shall fall within the protection scope of the present invention. The scope of protection of the invention is defined by the claims.

1. A method for improving point cloud classification accuracy based on map domain, comprising:
acquiring original point cloud data of 3D objects;
constructing a KNN graph on the original point cloud to represent the geometric structural information, wherein the said KNN graph is transformed from the data domain to the spectral domain through GFT;
creating spectral filters to filter the spectral features of the data transformed to the spectral domain, resulting in perturbed spectral signals;
using IGFT, converting the perturbed spectral signals back to the data domain, generating adversarial point cloud data;
generating samples based on the original point cloud data and adversarial samples based on the adversarial point cloud data, serving as training data, and inputting them into the point cloud classification model for classification training;
employing the trained point cloud classification model to classify the original point cloud data of the target 3D object, and providing the classification result as output.

2. The method according to claim 1, wherein the graph-spectral filter is a polynomial function of spectral eigenvalues, and the data transformed into the graph-spectral domain is perturbed in a learnable manner, and a perturbed spectrum is generated by minimizing the adversarial loss Signal.

3. The method according to claim 2, wherein the expression for minimizing the adversarial loss is as follows:
$${min}_{Δ} {L}_{a d v} ( {P}^{′} , P , y ) , ‖ {ϕ}_{GFT} ( {P}^{′} ) - {ϕ}_{GFT} ( P ) {‖}_{p} < ϵ ,$$
$$where$$
$${P}^{′} = {ϕ}_{IGFT} ( Δ ( {ϕ}_{GFT} ( P ) ) ,$$
$$Δ = [ \begin{matrix}{Δ}_{w , 1} \cdot {Σ}_{k = 0}^{K - 1} {Δ}_{h , k} {λ}_{1}^{k} & & \\ & ⋱ & \\ & & {Δ}_{w , n} \cdot {Σ}_{k = 0}^{K - 1} {Δ}_{h , k} {λ}_{n}^{k}\end{matrix} ]$$
wherein L_{adv}(P′, P, y) is the adversarial loss, P denotes the original point loud, P′ denotes the adversarial point cloud, ϕ_{GFT}( ) denotes the graph Fourier transform, ϕ_{IGFT}( ) denotes the inverse graph Fourier transform, y denotes the object class of point cloud, Δ denotes the learnable perturbation in the spectral domain, ∈ denotes the threshold restricting the perturbation, {Δ_{w,i}}ᵢ₌₁ⁿ is utilized to learn the contribution of each frequency component, {Δ_{h,k}}ₖ₌₀^{K} highlights the contributed frequency components, i and k are the index, n and K are the total number.

4. The method according to claim 3, wherein the adversarial learning loss L_{adv}(P′, P, y) is composed of a cross-entropy loss function L_{class}(P′,y) to facilitate combating point cloud misclassification, a regularization term L_{reg}(P′, P) and a low-frequency constraint L_{constrain}(\tilde{P}′, \tilde{P}), which is formulated as:
$${L}_{a d v} ( {P}^{′} , P , y ) = {L}_{c l a s s} ( {P}^{′} , y ) + {L}_{r e g} ( {P}^{′} , P ) + {L}_{c o n s t r a i n} ( \tilde{{P}^{′}} , \tilde{P} )$$
wherein, \tilde{P}′, \tilde{P} are the reconstructed point cloud by only utilizing the low-frequency component of P′, P.

5. The method according to claim 4, wherein,
$${L}_{c l a s s} ( {P}^{′} , y ) = \{ \begin{matrix}- {log}_{e} ( {p}_{{y}^{′}} ( {P}^{′} ) ) , & for targeted attack \\ {log}_{e} ( {p}_{y} ( {P}^{′} ) ) , & for untargeted attack\end{matrix} ;$$
wherein p(⋅) denotes the softmax functioned on the output of the target model, y denotes the object class of point cloud y′ denotes the adversarial class.

6. The method according to claim 4, wherein, L_{reg}(P′, P) is a regularization term that minimizes the distance between P′, P to guide the perturbation at appropriate frequencies.

7. The method according to claim 4, wherein,
$${L}_{c o n s t r a i n} ( \tilde{{P}^{′}} , \tilde{P} ) = {‖ \tilde{P} - \tilde{{P}^{′}} ‖}_{2} ;$$
$$wherein$$
$$\tilde{P} = U [ \begin{matrix}h ( {λ}_{1} ) & & \\ & ⋱ & \\ & & h ( {λ}_{n} )\end{matrix} ] {U}^{T} P$$
$$\tilde{{P}^{′}} = U [ \begin{matrix}h ( {λ}_{1} ) & & \\ & ⋱ & \\ & & h ( {λ}_{n} )\end{matrix} ] {U}^{T} {P}^{′}$$
h(λᵢ) is a low-pass graph filter:
$$h ( {λ}_{i} ) = \{ \begin{matrix}0 , & i > b \\ 1 , & i \leq b\end{matrix}$$
b is the upper bound of the low-frequency band.

8. A system for improving the accuracy of point cloud classification based on a map domain, comprising a memory and a processor, wherein the memory stores a computer program executing the steps of the method according to claim 1.

9. A system for improving the accuracy of point cloud classification based on a map domain, comprising a memory and a processor, wherein the memory stores a computer program executing the steps of the method according to claim 2.

10. A system for improving the accuracy of point cloud classification based on a map domain, comprising a memory and a processor, wherein the memory stores a computer program executing the steps of the method according to claim 3.

11. A system for improving the accuracy of point cloud classification based on a map domain, comprising a memory and a processor, wherein the memory stores a computer program executing the steps of the method according to claim 4.

12. A system for improving the accuracy of point cloud classification based on a map domain, comprising a memory and a processor, wherein the memory stores a computer program executing the steps of the method according to claim 5.

13. A system for improving the accuracy of point cloud classification based on a map domain, comprising a memory and a processor, wherein the memory stores a computer program executing the steps of the method according to claim 6.

14. A system for improving the accuracy of point cloud classification based on a map domain, comprising a memory and a processor, wherein the memory stores a computer program executing the steps of the method according to claim 7.
